(19) United States
(12) Patent Application Publication
(10) Pub. No.: US 2025/0256422 A1
(43) Pub. Date: Aug. 14, 2025

(54) PERFORATION SYSTEM AND METHOD FOR FORMING PERFORATIONS IN SIDE-WALLS OF GROUND-INSTALLED-PIPE

(71) Applicant: Atif Anwar SHAIKH, Kolhapur (IN)

(72) Inventor: Atif Anwar SHAIKH, Kolhapur (IN)

(21) Appl. No.: 19/047,623

(22) Filed: Feb. 7, 2025

(30) Foreign Application Priority Data
Feb. 12, 2024 (IN) 202421009496

(51) Int. Cl. B26F 1/18; B21D 28/28; F16L 55/40; F16L 101/10

(52) U.S. Cl. CPC B26F 1/18; B21D 28/28; F16L 55/40; F16L 2101/10

(57) ABSTRACT

Perforation system (100) and method for forming perforations in side-walls (05a) of ground-installed-pipe (05) without removal from the ground as known. Perforation system (100) includes a securing-element (10), a side-wall guiding elements (20), an actuator (30), a lead-screw (40), a lead-nut (50), a vertical-moving-guide-shaft (60), a flange (70), a tilting arrangement (80), a perforation tool (90) and a controlling unit (95). Perforation system (100) is inserted in the ground-installed-pipe (05) and the actuator (30) is actuated to achieve a tilting configuration of the perforation tool (90) to achieve forming perforation of cutting internally disposed foreign object (98) and in a non-titling configuration facilitates easy insertion and removal of the perforation system (100) from the ground-installed-pipe (05).

### FIELD OF THE INVENTION

The present disclosure relates to a perforation system and method for perforations of a ground-installed-pipe, like a bore-well pipe or tube-well pipe. Particularly, the present disclosure relates to a perforation system and method for forming perforations in side-walls and cutting foreign objection in side-walls of ground installed-pipes.

### BACKGROUND OF THE INVENTION

Bore-wells and tube-wells are pipes inserted in the ground to access water under the ground. Over a period of time, the water in the pipes gets dried-up. Further, the material (like mild steel or poly vinyl chloride-PVC) of the pipes may not allow seepage of water from surrounding water-containing aquifers into the pipes. Hence to make water available in the pipes, bores/holes are required to be drilled in pipes in the side-walls/longitudinal portion of the pipes so that the pipes are filled with water from surrounding water-containing aquifers. To drill bores/holes in the pipes, the known method, the pipes are to be pulled out from the ground and after pulling the pipes out from the ground, the holes/bores are drilled and then the pipes are reinstalled back in the ground. During the process of removing of the pipes and re-installing the pipes, the pipes may get damaged because of handling. Also, after removal of the pipes, the soil may be filled in the position of the removed pipes which is undesired. Thus, the known method may result in damage of pipes while handling, may block the space of the removed pipes, is labor (requires around 5 to 6 labors per pipe removal, drilling and reinstallation) and cost intensive requires portable and truck-mounted drilling/boring machines to be carried to the site which is challenging in urban areas due to space constraint for movement of vehicle and rural areas for lack of road infrastructure. Also, the drilling/boring machines needs to be operated on portable generators that consume fuel. Furthermore, the process of removing pipes, drilling bores/holes and re-installing may take approximately 7 to 8 hours. Known prior-arts such as the patent document WO2010131064 discloses a bore well casting pipe driller which discloses different components and requires manual adjustments.

Hence, there is a need for a perforation system and method for forming perforations in side-walls of a ground-installed-pipe/under-ground-installed-pipe, namely pipes of bore-wells or tube-wells, and alleviates some of the above mentioned drawbacks.

### OBJECTS OF THE INVENTION

Some of the objects of the arrangement of the present disclosure are aimed to ameliorate one or more problems of the prior art or to at least provide a useful alternative and are listed herein below.

A principle object of the present disclosure is to provide a perforation system and method for forming perforations in side-walls of a ground-installed-pipe (also termed as pipe/casing-pipe/under-ground-installed-pipe) that performs drilling/cutting of bore/hole and cutting of foreign objects inside the pipe without removal from the ground and has a tilting mechanism that facilitates cutting without damaging the pipe internally.

Another object of the present disclosure is to provide a perforation system and method for forming perforations in side-walls of a ground-installed-pipe that requires less labor due to elimination of operations of removing pipe, performing drilling and re-installing and hence less processing cost and processing time compared to conventional process.

Yet another object of the present disclosure is to provide a perforation system and method for forming perforations in side-walls of a ground-installed-pipe that has tilting arrangement that prevents damaging of the pipe.

Still another object of the present disclosure is to provide a perforation system and method for forming perforations in side-walls of a ground-installed-pipe that initiates drilling from bottom of the pipe and moves upwards towards the top of the pipe and hence in the event of water percolation the tool of the perforation system is prevented from being subjected to water.

Another object of the present disclosure is to provide a perforation system and method for forming perforations on the side-walls of a ground-installed-pipe that prevents the need of heavy vehicle to carrying heavy drilling machines at site and is convenient for use in rural and urban areas.

Yet another object of the present disclosure is to provide a perforation system and method for forming perforations in side-walls of a ground-installed-pipe that captures real-time images and videos of the perforation operations.

Other objects and advantages of the present disclosure will be more apparent from the following description when read in conjunction with the accompanying figures, which are not intended to limit the scope of the present disclosure.

### SUMMARY OF THE INVENTION

The present disclosure discloses a perforation system and method for forming perforations in side-walls of a ground-installed-pipe (also termed as pipe, casing pipe, under-ground-installed-pipe), in accordance with one embodiment of the present disclosure that performs drilling/cutting of bore/hole and foreign objects inside the pipe without removal from the ground and has a tilting mechanism that facilitates cutting or boring without damaging the pipe internally. The perforation system includes a securing-element, a side-wall guiding elements, an actuator, a lead-screw, a lead-nut, a vertical-moving-guide-shaft, a flange, a tilting arrangement, a perforation tool and a controlling unit. The securing-element is to be secured with a hoist-arrangement to be lowered and raised in the ground-installed-pipe. The side-wall guiding elements are in an in-line connection with the securing-element and during operation roll with the side-walls to provide guiding. The actuator in an in-line connection with the side-wall guiding element. The lead-screw in an in-inline and operative connection with the tool-actuator. The lead-nut is defined with linear movement on the lead-screw during rotation of the lead-screw by the actuator. The vertical-moving-guide-shaft is fitted with the lead-nut and is defined with linear movement with the lead-nut. The flange is defined with an opening through which the vertical-moving-guide-shaft linearly move. The tilting arrangement is defined with a first end and a second end. The first end is in connection with the flange. The second end is in pivotal connection with the vertical-moving-guide-shaft, in which, the tilting arrangement is defined with a tilting configuration and a non-tilting configuration. In the tilting configuration, the linear movement of the vertical-moving-guide-shaft is converted to tilting movement. In the non-tilting configuration, the vertical-moving-guide-shaft is defined to position the tilting arrangement in a non-tilting configuration. The perforation tool is in connection with the tilting arrangement and in the tilted configuration configured to perforate the side-wall and cut foreign objects from the side-wall and in the non-tilted configuration configured to rest. The controlling unit is defined to control the actuator to achieve the tilting configuration and non-tilting configuration and the hoist-arrangement for lowering and raising the securing-element. The hoist-arrangement secured with the securing-element is lowered to reach up to the depth in the ground-installed-pipe and the controlling unit is defined to perform a controlling set defined by:-actuate, in a first direction, the actuator to achieve the tilting configuration of the perforation tool and perforate the side-wall, and-actuate in a second direction opposite to the second direction, the actuator to achieve the non-tilting configuration of the perforation tool. The controlling unit controls the hoist-arrangement to be raised to a defined distance to perform the controlling set. The controlling unit is directed to de-actuate the actuator and the hoist arrangement.

In one embodiment, the actuator, the lead-screw and the lead-nut are enclosed by an enclosure pipe.

Typically, the actuator and the lead-screw connected by a coupler the perforation tool.

In one example, the perforation tool includes a horizontal cut slitting tool and a vertical slitting tool.

In additional embodiment, a camera is defined in the perforation system to capture real-time images of perforations.

The present disclosure also discloses a method for forming perforations in side-walls of a ground-installed-pipe, in accordance with one embodiment. The method includes:
providing a perforation system for forming perforation in side-walls of a ground-installed-pipe is defined with a securing-element which is to be secured to a hoist-arrangement, a side-wall guiding elements which is in an in-line connection with the securing-element, an actuator which is in an in-line connection with the side-wall guiding element, a lead-screw which is in an in-inline and operative connection with the tool-actuator, a lead-nut which is defined with linear movement on the lead-screw during rotation of the lead-screw by the actuator, a vertical-moving-guide-shaft is fitted with the lead-nut, a flange which is defined with an opening through which the vertical-moving-guide-shaft and linearly move, a tilting arrangement which is defined with a first end and a second end, the first end is in connection with the flange, the second end is in pivotal connection with the vertical-moving-guide-shaft, a perforation tool which is in connection with the tilting arrangement and a controlling unit;
lowering the securing-element by the hoist-arrangement, to a defined depth, wherein the portion of the side-wall guiding elements, which is in contact with the side-walls, roll thereon and provide guiding;
performing, by the controlling unit, a controlling set defined with:
   i. actuating, upon instruction of the controlling unit, the actuator, in a first direction, to rotate the lead-screw and convert to a linear movement by movement of the lead-nut on the lead-screw, movement of the lead-nut in-turn cause movement of the vertical-moving-guide shaft and the flange and cause the tilting arrangement to achieve the tilting configuration and cause perforation and cutting foreign objects by the perforation tool; and
   ii. reversing, upon instruction of the controlling unit, actuation of the actuator, in a second direction opposite to the first direction, to rotate the lead-screw in reverse direction and convert to a reverse-linear movement by reverse-movement of the lead-nut on the lead-screw, reverse-movement of the lead-nut in-turn causes reverse-movement of the vertical-moving-guide shaft and the flange and cause the tilting arrangement to achieve the non-tilting configuration and stop perforation of the side-walls and cutting foreign objects disposed on the side-walls by the perforation tool;
lifting, by the hoist-arrangement, the securing-element to a defined distance; and
repeating by the controlling unit performance of the controlling set;
wherein, the steps of lifting by the hoist-arrangement, the securing-element to a defined distance and the step of repeating by the controlling unit performance of the controlling set are repeated till the length of the ground-installed-pipe.

In one embodiment, the method includes the step of directing the hoist-arrangement for lowering and lifting the securing-element which is performed by the controlling unit.

Typically, the method includes the step of directing the hoist-arrangement for lowering and lifting the securing-element is performed by manually.

In one example, the method includes the step of capturing real-time images of perforations by a camera which is defined in the perforation system.

### BRIEF DESCRIPTION OF DRAWINGS

The present disclosure will now be described with the help of the accompanying drawings, in which:

FIG. 1 illustrates a schematic perspective representation of a perforation system (100) for forming perforations in side-walls (05a) of a ground-installed-pipe (05), in accordance with one embodiment, which includes a securing-element (10), a side-wall guiding elements (20), an actuator (30), a lead-screw (40), a lead-nut (50), a vertical-moving-guide-shaft (60), a flange (70), a tilting arrangement (80) and a controlling unit (95);

FIG. 2 illustrates a schematic internal view of the perforation system (100) of the FIG. 1, connected with a vertical slitting tool (90b) [which is one type of perforation tool (90)] and is in a non-tilting configuration and in rest state;

FIG. 3 illustrates a schematic view of the perforation system (100) of the FIG. 2 with dimensions, wherein A=350.43 mm, B=160 mm, C=340 mm, D=261 mm and E=110 mm;

FIG. 4 illustrates a schematic view of the perforation system (100) of the FIG. 2 in which the vertical slitting tool (90b) is tilted backward defining a tilting configuration of 5 degree which is denoted by F and the linear distance G=75 mm;

FIG. 5 illustrates a schematic view of the perforation system (100) of the FIG. 2 in which the vertical slitting tool (90b) is tilted forward defining a tilting configuration for cutting of 5 degree which is denoted by H and the linear distance I=75 mm;

FIG. 6 illustrates a schematic representation of the perforation system (100) of the FIG. 2 introduced in the ground-installed-pipe (05) in which the vertical slitting tool (90b) is in rest and representing the non-tilting configuration, this facilitates easy insertion of the perforation system (100) in the ground-installed-pipe (05);

FIG. 7 illustrates a schematic representation of the perforation system (100) of the FIG. 2 introduced in the ground-installed-pipe (05) in which the vertical slitting tool (90b) is in vertically cutting the ground-installed-pipe (05) and representing the tilting configuration;

FIG. 8 illustrates a schematic internal view of the perforation system (100) of the FIG. 1, connected with a horizontal slitting tool (90a) [which is another type of perforation tool (90)] and is in a non-tilting configuration and in rest state in which J=335, K=160, L=340, and M=261;

FIG. 9 illustrates a schematic representation of the perforation system (100) of the FIG. 8 introduced in the ground-installed-pipe (05) in which the horizontal slitting tool (90a) is in rest and representing the non-tilting configuration, this facilitates easy insertion of the perforation system (100) in the ground-installed-pipe (05);

FIG. 10 illustrates a schematic representation of the perforation system (100) of the FIG. 2 introduced in the ground-installed-pipe (05) in which the vertical slitting tool (90b) perforates the ground-installed-pipe (05) and representing the tilting configuration;

FIG. 11 illustrates a schematic representation of the perforation system (100) of the FIG. 8 introduced in the ground-installed-pipe (05) in which the horizontal slitting tool (90a) cuts foreign objects (like roots of plants) disposed within the ground-installed-pipe (05) and representing the tilting configuration;

FIG. 12 illustrates a schematic representation of the perforation system (100) disclosing the tilting arrangement (80) in non-tilted configuration; and

FIG. 13 illustrates an exploded view of the perforation system of FIG. 2.

### DETAILED DESCRIPTION OF THE INVENTION

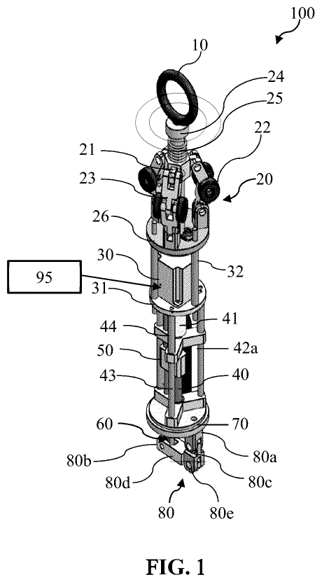

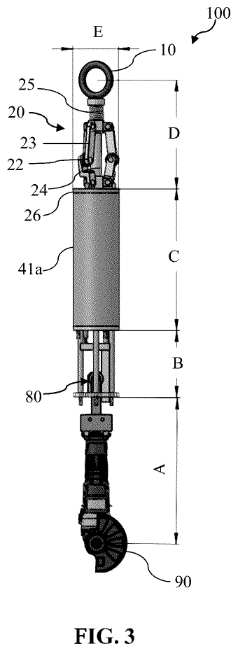

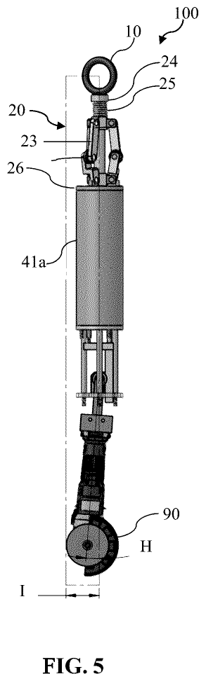

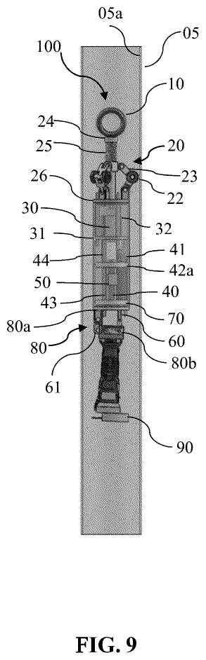

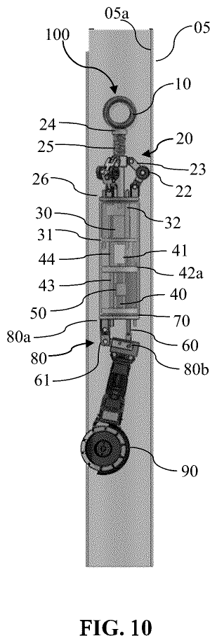

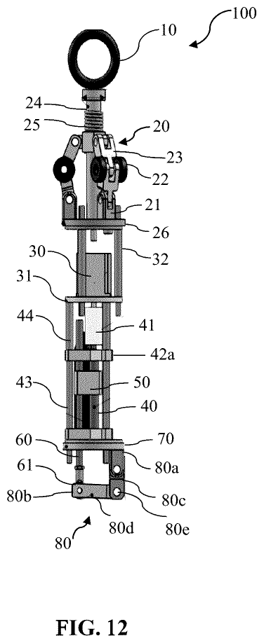

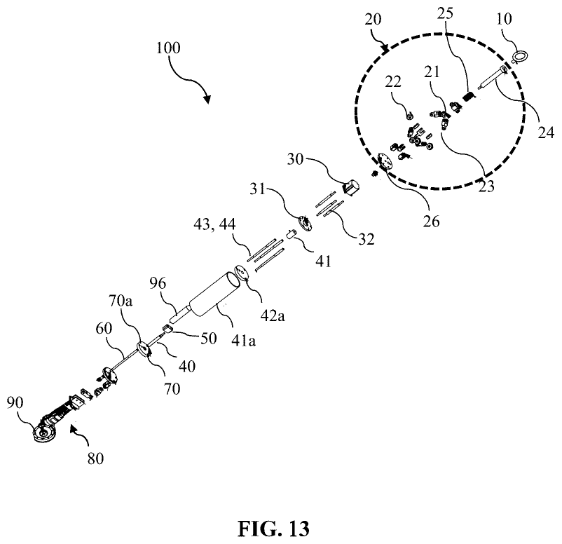

Referring now to the drawings, FIGS. 1 to 13, where the present invention is generally referred to with numeral (100), it can be observed that a perforation system, in accordance with an embodiment, for forming perforations in side-walls (05a) of a ground-installed-pipe (05) (also termed as pipe, casing pipe, under-ground-installed-pipe) is provided which includes a securing-element (10), a side-wall guiding elements (20), a actuator (30), a lead-screw (40), a lead-nut (50), a vertical-moving-guide-shaft (60), a flange (70), a tilting arrangement (80), a perforation tool (90) and a controlling unit (95). Typically, the ground-installed-pipe (05) are made of mild steel, Poly Vinyl Chloride or galvanized.

The securing-element (10) is to be secured with a hoist-arrangement to be lowered and raised in the ground-installed-pipe (05) like tube-well or bore-well. In one embodiment, the securing-element (10) is an eye-bolt. Typically, the eye-bolt used is M16, however other sizes of eye-bolt can be used depending on the size of the perforation system (100).

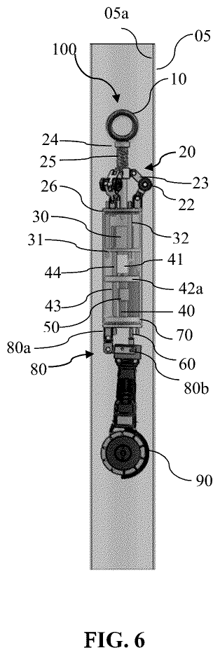

The side-wall guiding elements (20) are in an in-line connection with the securing-element (10). During operations, the side-wall guiding elements (20) roll with the side-walls (05a) to provide guiding. In one embodiment, the side-wall guiding elements (20) are formed by a side-wall-guide-hinge-plate (21), a side-wall-guide-bearing (22) and a side-wall-hinge-pin (23). Typically, the side-wall-guide-hinge-plate (21) is of size 20×10×100 mm. Typically, the side-wall-guide-bearing (22) is SKF 6201. Typically, the side-wall-hinge-pin (23) is of 12 mm diameter. Considering the pressure within the ground-installed-pipe (05), the perforation system (100) has to move gradually inside the ground-installed-pipe (05) and needs to be properly guided by the side-wall-guide-hinge-plate (21) with the side-wall-guide-bearing (22) and helps to align the perforation system (100) with the side walls (05a). The side-wall-hinge-pin (23) holds the side-wall-guide-bearing (22) together with the side-wall-guide-hinge-plate (21). More specifically, FIGS. 6, 7 and 9 depicts that the side-wall-guide-bearing (22) touches the side walls (05a) and hence guides the perforation system (100). Typically, a guide rod (24) is provided with a spring (25) to support and allow movement of the side-wall guiding elements (20) thereon. Typically, the side-wall guiding elements (20) are supported on a top flange (26).

The actuator (30) is in an in-line connection with the side-wall guiding element (20). In one embodiment, the actuator (30) is a stepper motor. The operations (of actuating and de-actuating) of the actuator (30) are controlled by the controlling unit (95). The operation of the actuator (30) provides angular movement to the perforation tool (90). Typically, the actuator (30) can be Bholanath make stepper motor with specification of NEMA 24 (60 mm) BH60SH65-2804AF having torque of 2.1 NM current requirement of 2.8 A, voltage of 3.36V and runs on 230V DC. The actuator (30) is positioned on a mounting plate (31) which is connected to the top flange (26) by tie rods (32).

The lead-screw (40) in an in-inline and in an operative connection with the tool-actuator (30). Typically, the lead-screw (40) is defined with M16×2 mm pitch. In one embodiment, the lead-screw (40) is connected to the actuator (30) by a coupler (41) transmits rotary movement from the actuator (30) to the lead-screw (40). The lead-screw (40) is disposed between a lead-screw mounting plate (42a) and the flange (70) connected by tie rods (43). The coupler (41), typically a flexible coupler, is disposed between the lead-screw mounting plate (42a) and the mounting plate (31) connected by tie rods (44). The tie rods (44) and the tie rods (43) can be integral or can be separate. The tie rods (43, 44) provide spacing to accommodate the coupler (41) and the lead-screw (40).

The lead-nut (50) is defined with the linear movement on the lead-screw (40) during rotation of the lead-screw (40) by the actuator (30). More specifically, the rotation of the actuator (30) in a first direction can linear move the lead-nut (50) downward on the lead-screw (40) and the rotation of the actuator (30) in a second direction can linear move the lead-nut (50) upward on the lead-screw (40). The first direction is opposite to the second direction. For example, if the first direction is clockwise then the second direction is anti-clockwise. The terms—the first direction, the second direction, clockwise, anticlockwise, upward and downward can be modified/altered depending on the set-up of the mechanism and hence not limited to as mentioned above. For example, the first direction can be termed for clockwise and the second direction can be termed for anti-clockwise or the first direction can linear move the lead-nut (50) upward on the lead-screw (40) and the second direction can linear move the lead-nut (50) downward on the lead-screw (40).

In one embodiment, the actuator (30), the coupler (41), the lead-screw (40) and the lead-nut (50) are enclosed by an enclosure pipe (41a) that provides safety and protection. The enclosure pipe (41a) is of diameter 110 MM×320 MM long.

The vertical-moving-guide-shaft (60) is fitted with the lead-nut (50) and is defined with linear movement with the lead-nut (50). Typically, the vertical-moving-guide-shaft (60) is 12 mm long.

The flange (70) is defined with an opening (70a) through which the vertical-moving-guide-shaft (60) linearly moves.

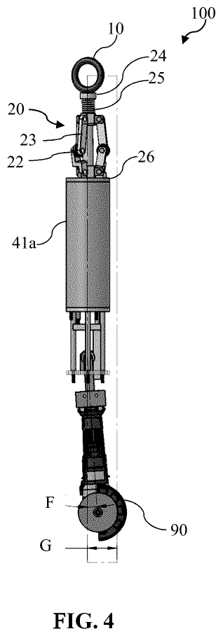

The tilting arrangement (80) is defined with a first end (80a) and a second end (80b). The first end (80a) is in connection with the flange (70). The second end (80b) is in pivotal connection (61) with the vertical-moving-guide-shaft (60). The tilting arrangement (80) is defined with a tilting configuration (as shown in FIGS. 4, 5, 6, 7, 9, 10, 11) and a non-tilting configuration (as shown in FIGS. 1, 2, 3, 8, 12). In one exemplary embodiment, the tilting arrangement (80) is made of a first link (80c) which is defined with the first end (80a) and a second link (80d) which is defined with the second end (80b). The first link (80c) is pivotally connected (80e) with the second link (80b). Typically, the first link (80c) can be made of multiple links having pivotal connections or can be one link. Typically, the second link (80d) can be made of multiple links having pivotal connections or can be one link. In the tilting configuration the linear movement of the vertical-moving-guide-shaft (60) is converted to tilting movement. In the non-tilting configuration the vertical-moving-guide-shaft (60) is defined to position the tilting arrangement (80) in a non-tilting configuration. The tilting arrangement (80) tilts at an angular 15 degrees and linear movement of 50 mm. However, the tilting arrangement (80) can tilt in the range from +25 degrees to −25 degrees.

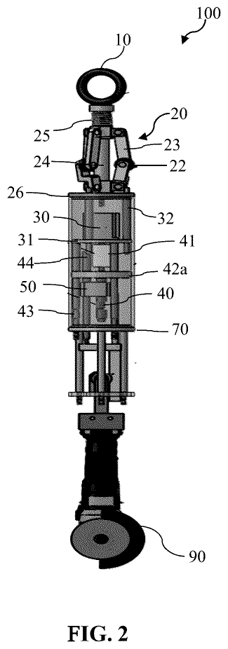

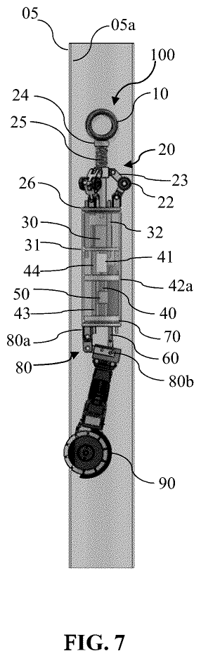

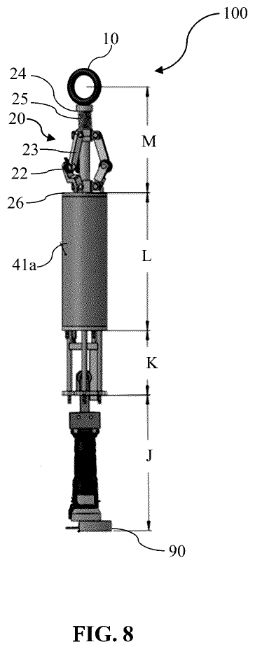

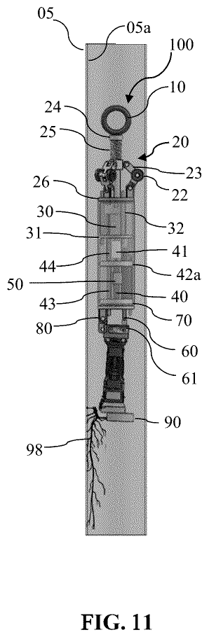

The perforation tool (90) is in connection with the tilting arrangement (80) and in the tilted configuration configured to perforate the side-wall (05) (as shown in FIG. 7, 10) and cut foreign objects from the side-wall (05) (as shown in FIG. 11) and in the non-tilted configuration configured to rest. In one embodiment, the perforation tool (90) is selected from a vertical slitting tool (90b) (as shown in FIGS. 2 to 7) and a horizontal slitting tool (90a) (as shown in FIGS. 8, 9 and 11) depending on the need of the cut required. Typically, the perforation tool (90) can make perpendicular or horizontally cuts or slice of 0.5 mm width and 2 to 6 inches in height in the side-wall (05).

The controlling unit (95) is defined to control the actuator (30) to achieve the tilting configuration and non-tilting configuration and the hoist-arrangement for lowering and raising the securing-element (10). In operation, the hoist-arrangement is secured with the securing-element (10) and the securing-element (10) is lowered to reach a depth in the ground-installed-pipe (05) and the controlling unit (95) is defined to perform a controlling set defined by:
actuate, in the first direction, the actuator (30) to achieve the tilting configuration of the perforation tool (90) and perforate the side-wall (05), and
actuate in the second direction opposite to the second direction, the actuator (30) to achieve the non-tilting configuration of the perforation tool (90).

The controlling unit (95) controls the hoist-arrangement to be raised to a defined distance to perform the controlling set. The controlling unit (95) is directed to de-actuate the actuator (30) and the hoist arrangement. The controlling unit (95) can be controlled by a mobile application or a computing device or by use of controlling devices like keypad, touchscreen and the like known controlling devices. Typically, the controlling unit (95) can be PLC based control unit.

In one embodiment, the camera (96) captures real-time images of perforations and sends to a display unit (not shown). The camera (96) is operated by the controlling unit (95) and the locations of foreign objects (98) is determined by the camera (96) and communicated to the controlling unit (95) that informs the knowledgeable experts. Typically, the camera (96) can be waterproof vision camera which can capture image at 1000 feet deep inside the ground-installed-pipe (05) having low light. Additionally, a light source (not shown) can travel with the camera (96). In additional embodiment, the camera (96) is connected to a display unit (not shown) which is disposed outside the ground-installed-pipe (05) to know real-time internal conditions. The display unit can be any screen of computer handheld devices including smart phones. The display unit can be connected to the camera (96) by wired or wireless technologies.

The present disclosure also discloses a method for forming perforations in side-walls (05a) of a ground-installed-pipe (05), in accordance with one embodiment. The present embodiment discloses the best method for forming perforations in side-walls (05a) of a ground-installed-pipe (05). The first step is providing the perforation system (100) as disclosed in the above paragraphs. In short, the perforation system (100) is defined with the securing-element (10) which is secured to the hoist-arrangement, the side-wall guiding elements (20) which is in an in-line connection with the securing-element (10), the actuator (30) which is in an in-line connection with the side-wall guiding element (20), the lead-screw (40) which is in an in-inline and operative connection with the tool-actuator, the lead-nut (50) which is defined with linear movement on the lead-screw (40) during rotation of the lead-screw (40) by the actuator (30), the vertical-moving-guide-shaft (60) which is fitted with the lead-nut (50), the flange (70) is defined with an opening through which the vertical-moving-guide-shaft (60) linearly move, the tilting arrangement (80) is defined with the first end (80a) and the second end (80b). The first end (80a) is in connection with the flange (70). The second end (80b) is in pivotal connection with the vertical-moving-guide-shaft (60), the perforation tool (90) is in connection with the tilting arrangement (80) and the controlling unit (95). It is to be noted that each and every feature of the perforation system (100) as described in the above paragraphs is applicable to the method of the present paragraph and the steps of the method disclosed in the present paragraph is applicable to the perforation system (100) as described in the above paragraphs.

The next step is lowering the securing-element (10), by the hoist-arrangement, to the defined depth. The defined depth is known from geologist, hydrologist or other knowledgeable expert persons. In which, the portion of the side-wall guiding elements (20), in contact with the side-walls (05a), roll thereon and provide guiding. Initially, the camera (96) of the perforation system (100) is introduced in the ground-installed-pipe (05), such as the bore-well or tube-well and the internal conditions like obstacles or presence of foreign object (98) and locations of foreign objects/obstacles (98) by the data received from the controlling unit (95). The controlling unit (95) signals the hoist arrangement to lower the perforation system (100) and allow cutting of the foreign objects/obstacles (98) or the knowledgeable experts suggest laborers (i.e. manual operation) to operate and lower the perforation system (100).

The next step is performing, by the controlling unit (95), a controlling set defined with:
actuating, upon instruction of the controlling unit (95), the actuator (30), in the first direction, to rotate the lead-screw (40) (typically in clockwise direction) and converts to the linear movement by movement of the lead-nut (50) on the lead-screw (40), movement (downward movement) of the lead-nut (50) in-turn cause movement (downward movement) of the vertical-moving-guide shaft (60) and the flange (70) and causes the tilting arrangement (80) to achieve the tilting configuration and cause perforation and/or cutting foreign objects (98) by the perforation tool (90); and
reversing, upon instruction of the controlling unit (95), actuation of the actuator (30), in the second direction (anticlockwise direction) opposite to the first direction (clockwise direction), to rotate the lead-screw (40) in reverse (upward) direction and convert to the reverse-linear movement by reverse-movement (upward movement) of the lead-nut (50) on the lead-screw (40), reverse-movement (upward movement) of the lead-nut (50) in-turn cause reverse-movement (upward movement) of the vertical-moving-guide shaft (60) and the flange (70) and cause the tilting arrangement (80) to achieve the non-tilting configuration i.e. the rest condition and stop perforation of the side-walls (05a) and cutting foreign objects (98) disposed on the side-walls (05a) by the perforation tool (90).

Further, the next step is lifting, by the hoist-arrangement, the securing-element (10) to the defined distance which is defined by knowledgeable experts, geologist or hydrologist and fed in the controlling unit (95) based on the length of pipe and the water availability in the surrounding aquifers. The defined distance is the distance between two adjacent perforations as defined by the knowledgeable experts.

The next step is repeating by the controlling unit (95) performance of the controlling set (30), in which, the steps of lifting by the hoist-arrangement, the securing-element (10) to the defined distance and the step of repeating by the controlling unit (95) performance of the controlling set (30) are repeated till the length of the ground-installed-pipe (05) or as defined by the knowledgeable experts.

Typically, the method includes the step of capturing real-time images of perforations by the camera (96) defined in the perforation system (100).

The perforation system (100) and method, as described above and illustrated in FIGS. 1 to 13, is for forming perforations in side-walls (05a) of a ground-installed-pipe (05) (also termed as pipe) performs drilling/cutting of bore/hole and foreign objects inside the pipe without removal from the ground and has a tilting mechanism that facilitates cutting or boring without damaging the pipe internally. The perforation system (100) and method for forming perforations in side-walls (05a) of the ground-installed-pipe (05) requires less labor due to elimination of operations of removing pipe, performing drilling and re-installing and hence less processing cost and processing time compared to conventional process. The perforation system (100) and method for forming perforations in side-walls (05a) of a ground-installed-pipe (05) has tilting arrangement that prevents damaging of the pipe. The perforation system (100) and method for forming perforations in side-walls (05a) of a ground-installed-pipe (05) initiates drilling from bottom of the pipe and moves towards the top of the pipe and hence in event of water percolation the perforation system is prevented from being subjected to water. The perforation system (100) and method for forming perforations in side-walls (05a) of the ground-installed-pipe (05) prevents the need of heavy vehicle to carrying heavy drilling machines at site and is convenient for use in rural and urban areas. The perforation system (100) and method for forming perforations in side-walls (05a) of the ground-installed-pipe (05) captures real-time images and videos of the perforation operations. The perforation system (100) is typically 18 kilograms in weight.

The contents and features of the perforation system (100) as disclosed in paragraphs [008 to 020] is applicable to the method for forming perforations in side-walls (05a) of a ground-installed-pipe (05) as disclosed from paragraphs [021 to 26] and vice-versa.

The foregoing description conveys the best understanding of the objectives and advantages of the present invention. Different embodiments, steps or alternatives may be made of the inventive concept of this invention. It is to be understood that all matter disclosed herein is to be interpreted merely as illustrative, and not in a limiting sense.

What is claimed is:

1. A perforation system (100) for forming perforations in side-walls (05a) of a ground-installed-pipe (05), said comprising:
Characterized by:
a securing-element (10) to be secured with a hoist-arrangement to be lowered and raised in the ground-installed-pipe (05);
a side-wall guiding elements (20) in an in-line connection with said securing-element (10) and during operation roll with the side-walls (05a) to provide guiding;
an actuator (30) in an in-line connection with said side-wall guiding element (20);
a lead-screw (40) in an in-inline and in an operative connection with said tool-actuator (30);
a lead-nut (50) defined with linear movement on the lead-screw (40) during rotation of said lead-screw (40) by said actuator (30);
a vertical-moving-guide-shaft (60) fitted with said lead-nut (50) and defined with linear movement with said lead-nut (50); and
a flange (70) defined with an opening through which said vertical-moving-guide-shaft (60) linearly move;
a tilting arrangement (80) defined with a first end (80a) and a second end (80b), said first end (80a) in connection with said flange (70), said second end (80b) in pivotal connection (61) with said vertical-moving-guide-shaft (60), wherein, said tilting arrangement (80) defined with a tilting configuration and a non-tilting configuration,
wherein, in said tilting configuration the linear movement of said vertical-moving-guide-shaft (60) is converted to tilting movement,
wherein, in said non-tilting configuration said vertical-moving-guide-shaft (60) is defined to position said tilting arrangement (80) in a non-tilting configuration;
a perforation tool (90) in connection with said tilting arrangement (80) and in the tilted configuration configured to perforate the side-wall (05) and cut foreign objects (98) from the side-wall (05) and in the non-tilted configuration configured to rest; and
a controlling unit (95) defined to control said actuator (30) to achieve the tilting configuration and non-tilting configuration and said hoist-arrangement for lowering and raising said securing-element (10),
wherein, said hoist-arrangement secured with said securing-element (10) is lowered to reach a depth in the ground-installed-pipe (05) and said controlling unit (95) is defined to perform a controlling set defined by:
actuate, in a first direction, said actuator (30) to achieve the tilting configuration of said perforation tool (90) and perforate said side-wall (05), and
actuate in a second direction opposite to the second direction, said actuator (30) to achieve the non-tilting configuration of said perforation tool (90);
wherein, said controlling unit (95) controls said hoist-arrangement to be raised to a defined distance to perform the controlling set,
wherein, said controlling unit (95) directed to de-actuate said actuator (30) and said hoist arrangement.

2. The perforation system (100) for forming perforations in side-walls (05a) of a ground-installed-pipe (05) as claimed in claim 1, wherein said actuator (30), said lead-screw (40) and said lead-nut (50) enclosed by an enclosure pipe (41a).

3. The perforation system (100) for forming perforations in side-walls (05a) of a ground-installed-pipe (05) as claimed in claim 1, wherein said actuator (30) and said lead-screw (40) connected by a coupler (41).

4. The perforation system (100) for forming perforations in side-walls (05a) of a ground-installed-pipe (05) as claimed in claim 1, wherein said perforation tool (90) includes a horizontal cut slitting tool (90a) and a vertical slitting tool (90b).

5. The perforation system (100) for forming perforations in side-walls (05a) of a ground-installed-pipe (05) as claimed in claim 1, includes a camera (96) to capture real-time images of perforations.

6. A method for forming perforations in side-walls (05a) of a ground-installed-pipe (05), said method comprising:
Characterized by:
providing a perforation system (100) for forming perforation in side-walls (05a) of a ground-installed-pipe (05) defined with a securing-element (10) secured to a hoist-arrangement, a side-wall guiding elements (20) in an in-line connection with said securing-element (10), an actuator (30) in an in-line connection with said side-wall guiding element (20), a lead-screw (40) in an in-inline and operative connection with said tool-actuator, a lead-nut (50) defined with linear movement on the lead-screw (40) during rotation of said lead-screw (40) by said actuator (30), a vertical-moving-guide-shaft (60) fitted with said lead-nut (50), a flange (70) defined with an opening through which said vertical-moving-guide-shaft (60) linearly move, a tilting arrangement (80) defined with a first end (80a) and a second end (80b), said first end (80a) in connection with said flange (70), said second end (80b) in pivotal connection with said vertical-moving-guide-shaft (60), a perforation tool (90) in connection with said tilting arrangement (80) and a controlling unit (95);
lowering said securing-element (10) by said hoist-arrangement, to a defined depth, wherein the portion of said side-wall guiding elements (20), in contact with the side-walls (05a), roll thereon and provide guiding;
performing, by said controlling unit (95), a controlling set defined with:
actuating, upon instruction of said controlling unit (95), said actuator (30), in a first direction, to rotate said lead-screw (40) and convert to a linear movement by movement of said lead-nut (50) on said lead-screw (40), movement of said lead-nut (50) in-turn cause movement of said vertical-moving-guide shaft (60) and said flange (70) and cause said tilting arrangement (80) to achieve the tilting configuration and cause perforation and cutting foreign objects (98) by said perforation tool (90); and
reversing, upon instruction of said controlling unit (95), actuation of said actuator (30), in a second direction opposite to the first direction, to rotate said lead-screw (40) in reverse direction and convert to a reverse-linear movement by reverse-movement of said lead-nut (50) on said lead-screw (40), reverse-movement of said lead-nut (50) in-turn cause reverse-movement of said vertical-moving-guide shaft (60) and said flange (70) and cause said tilting arrangement (80) to achieve the non-tilting configuration and stop perforation of the side-walls (05a) and cutting foreign objects (98) disposed on said side-walls (05a) by said perforation tool (90);
lifting, by said hoist-arrangement, said securing-element (10) to a defined distance; and
repeating by said controlling unit (95) performance of the controlling set (30);
wherein, said steps of lifting by said hoist-arrangement, said securing-element (10) to a defined distance and said step of repeating by said controlling unit (95) performance of the controlling set (30) are repeated till the length of the ground-installed-pipe (05).

7. The method for forming perforations in side-walls (05a) of a ground-installed-pipe (05) as claimed in claim 6, includes the step of directing said hoist-arrangement for lowering and lifting said securing-element (10) is performed by said controlling unit (95).

8. The method for forming perforations in side-walls (05a) of a ground-installed-pipe (05) as claimed in claim 6, includes the step of directing said hoist-arrangement for lowering and lifting said securing-element (10) is performed by manually.

9. The method for forming perforations in side-walls (05a) of a ground-installed-pipe (05) as claimed in claim 6, includes the step of capturing real-time images of perforations by a camera (96) defined in said perforation system (100).
